(19) United States
(12) Patent Application Publication
(10) Pub. No.: US 2026/0225032 A1
(43) Pub. Date: Aug. 6, 2026

(54) ROTATING PACKED BED REACTOR

(71) Applicant: Schlumberger Technology Corporation, Sugar Land, TX (US)

(72) Inventors: Gocha CHOCHUA, Sugar Land, TX (US); Eric LAVRUT, Clamart (FR); Z. Frank ZHENG, Sugar Land, TX (US); Sara ESCANERO, Sugar Land, TX (US); Shu PAN, Calgary (CA); ke Ken LI, Sugar Land, TX (US)

(21) Appl. No.: 19/151,306

(22) PCT Filed: Jun. 21, 2024
(86) PCT No.: PCT/US2024/035022

§ 371 Date: Jul. 26, 2025

Related U.S. Application Data
(60) Provisional application No. 63/509,287, filed on Jun. 21, 2023.
(60) Provisional application No. 63/509,414, filed on Jun. 21, 2023.

(51) Int. Cl. B01D 53/18; B01D 53/14; B01D 53/34; B01D 53/62; B01D 53/78

(52) U.S. Cl. CPC B01D 53/18; B01D 53/1412; B01D 53/1475; B01D 53/1493; B01D 53/346; B01D 53/62; B01D 53/78; B01D 2252/204; B01D 2257/504

(57) ABSTRACT

An apparatus for a rotating packed bed reactor (RPB) that may be used to increase the mass-transfer rate between materials, such as a gas and a liquid, through the RPB. The rotor of the RPB may be rotatably driven within a housing at least in part by the direction of a gas in a tangential direction relative to an outer circumferential surface of the rotor. An RPB may include a housing having a gas inlet, a liquid inlet, a gas outlet, and a liquid outlet. The rotor includes a permeable packing configured to facilitate contact between the liquid and the gas passing through the permeable packing while the rotor rotates with respect to the housing. The gas inlet is configured to direct the gas tangentially with respect to the outer circumferential surface of the rotor to thereby cause the rotor to rotate with respect to the housing.

### CROSS-REFERENCE TO RELATED APPLICATIONS

The present application claims priority to and the benefit of U.S. Provisional Patent Application No. 63/509,287 entitled “Rotating Packed Bed Reactor” filed Jun. 21, 2023 and U.S. Provisional Patent Application No. 63/509,414 entitled “Rotating Packed Bed Reactors” filed Jun. 21, 2023, the disclosures of which are incorporated herein by reference in their entirety.

### BACKGROUND OF THE DISCLOSURE

Separation processes play a vital role in heavy processing, chemical, petrochemical, and pharmaceutical industries. Separation processes are used, for example, to extract and dispose of atmospheric gas pollutants (e.g., flue gases), such as sulfur dioxide, hydrogen sulfide, nitrous oxide, ammonia, various hydrocarbons, and carbon dioxide, which contribute to global warming. Processes that use liquids containing such dissolved gases can lead to deterioration of end products as well as damage to equipment performing such processes.

Packed bed columns (PBCs) are often used to perform separation processes. PBCs use Earth's gravity to cause a liquid to flow contra-directionally to a stream of gas. In PBCs, liquid-gas contact area and gravity determine achievable liquid and gas throughputs and mass-transfer rates that, in turn, stipulate the relatively large size and bulkiness of the PBCs for industrial-scale facilities. Example PBCs include distillation columns, absorption columns, stripping columns, and contacting columns.

Rotating packed bed (RPB) reactors, which are more compact than the packed bed columns, can instead be used to perform separation processes to overcome low mass-transfer rates of conventional PBCs. RPB reactors, which are also known as HiGees (or high gravity reactors), utilize rotation to generate centrifugal forces that are hundreds of times greater than the force of gravity, permitting the use of permeable packings having larger surface areas to increase mass-transfer rates. Under the high centrifugal forces formed by RPB reactors, the liquid flows along the permeable packing as a thin film, resulting in an increase in the liquid-side mass-transfer coefficient, which can be many times higher than in conventional PBCs. As a result, RPB reactors can be many times smaller than conventional PBCs.

### BRIEF SUMMARY

In some embodiments, an apparatus includes a rotating packed bed reactor having a housing and a rotor. The housing includes a gas inlet, a liquid inlet, a gas outlet, and a liquid outlet. The rotor is disposed within the housing. The rotor is rotatable with respect to the housing. The rotor includes an outer circumferential surface. The rotor includes a permeable packing configured to facilitate contact between a liquid and a gas passing through he permeable packing while the rotor rotates with respect to the housing. The gas inlet is configured to direct the gas tangentially with respect to the outer circumferential surface of the rotor to thereby cause the rotor to rotate with respect to the housing.

In some embodiments, a method of operating a rotating packed bed reactor includes injecting a liquid into an axial space of a rotor, driving the rotor with a gas, flowing a liquid radially from the axial space to an outer circumferential surface, directing the liquid through a liquid outlet of a housing, and directing the gas to a gas outlet of the housing. The rotor may include a central axis within the axial space. The rotor may be driven about the central axis by directing the gas through a first gas inlet of the housing of the rotating packed bed reactor in a tangential direction. The rotor is disposed within the housing, is rotatable with respect to the housing, and includes a permeable packing. The liquid is flowed radially from the axial space to the outer circumferential surface of the rotor based at least in part by a centrifugal force of the rotor on the liquid. The gas is directed radially through the outer circumferential surface to a gas outlet of the housing.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic sectional side view of at least a portion of an example implementation of apparatus according to one or more aspects of the present disclosure.

FIG. 2 is a sectional axial view of the apparatus shown in FIG. 1.

FIG. 3 is a schematic sectional axial view of at least a portion of an example implementation of apparatus according to one or more aspects of the present disclosure.

FIG. 4 is a schematic sectional axial view of at least a portion of an example implementation of apparatus according to one or more aspects of the present disclosure.

FIG. 5 is a schematic sectional axial view of at least a portion of an example implementation of apparatus according to one or more aspects of the present disclosure.

FIG. 6 is a schematic sectional axial view of at least a portion of an example implementation of apparatus according to one or more aspects of the present disclosure.

FIG. 7 is a schematic sectional axial view of at least a portion of an example implementation of apparatus according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

The compactness of RPB reactors is a sought-after parameter governing applicability of the RPB reactors. However, providing pollutant capture services for modern industrial-scale power plants utilizing fossil fuels can still utilize hundreds of RPB reactors per 1 Gigawatt of generated energy, resulting in a pollutant capture facility having a size comparable with the power plant itself. Although RPB reactors are successfully operating in the industry, internal processes of RPB reactors are not fully understood, and their architecture and optimal design parameters are still under research and development. The existing research and development are governed not just by diversity and range of operational parameters (e.g., gas sweetening, oxygen removal, carbon removal, etc.), but also, aimed at providing RPB reactors with a more efficient and compact design, such as by increasing throughput (i.e., mass transfer or flow rate) and decreasing physical size (i.e., footprint).

The rotating portion of a RPB reactor is referred to as a rotating packed bed (or a rotor) of the RPB reactor. The rotor is rotated by a motor mechanically connected to the rotor via a shaft that extends through a housing of the RPB reactor. Fluid seals are installed between the housing and the shaft to prevent or inhibit the liquid and gas from leaking out of the housing. Torque and rotational speed of the motor are controlled by a motor drive. The use of a motor to rotate the rotor adds significant amount of size, weight, complexity, and cost to a RPB reactor.

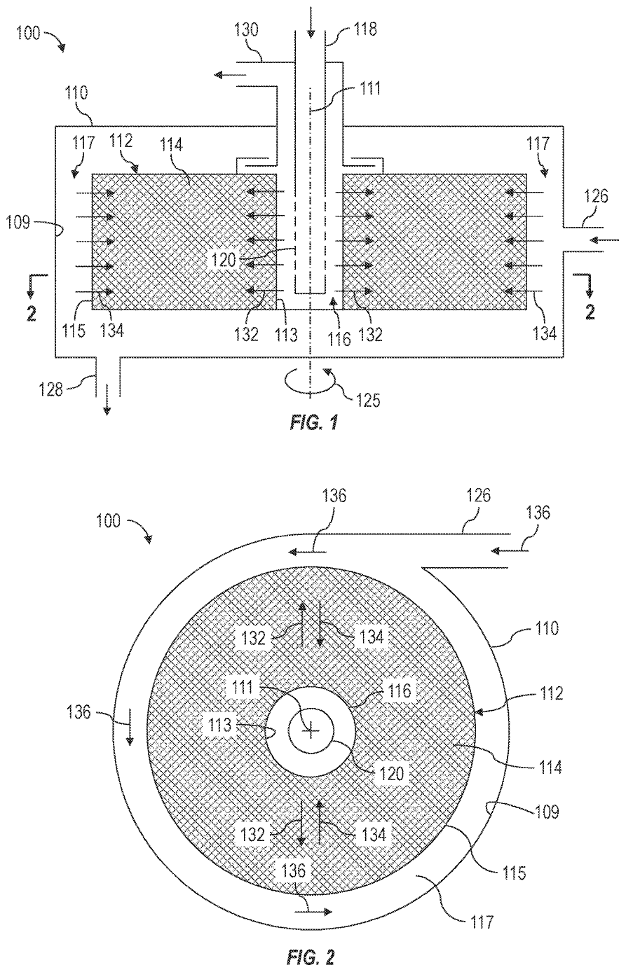

FIG. 1 is a schematic sectional side view of at least a portion of an RPB reactor 100 according to one or more aspects of the present disclosure. FIG. 2 is a sectional axial view of the RPB reactor 100 shown in FIG. 1. The RPB reactor 100 may comprise a housing 110 (also referred to as a casing or collector) containing a rotor 112 (i.e., a rotating packed bed) configured for rotation within and with respect to the housing 110. The rotor 112 may be rotatable about its central axis 111, as indicated by arrow 125. The rotor 112 may comprise a permeable liquid-gas reaction (or contact) region in the form of or otherwise defined by a permeable (or porous) packing 114 having internal and/or external surface areas along which the liquid and gas can flow and contact each other and, thus, facilitate mass transfer between the liquid and gas. The rotor 112 (including the permeable packing 114) may comprise an annular geometry. For example, the rotor 112 (and the permeable packing 114) may comprise an inner circumferential (or radial) surface (or inner circumference) 113 having an inner diameter and defining an axial (or central) space 116 extending axially at least partially through the rotor 112. The axial space 116 may extend along the central axis 111. The rotor 112 (and the permeable packing 114) may further comprise an outer circumferential (or radial) surface (or outer circumference) 115 having an outer diameter and defining an external annular space (or collector area) 117 extending around the rotor 112 between the outer circumferential surface 115 and an inner circumferential surface (or inner circumference) 109 of the housing 110.

The permeable packing 114 may be or comprise metal or non-metal particles, fillers, beads, or other members (e.g., metal balls, glass balls, metal-oxide particles, ceramic particles, etc.) defining gaps or other spaces therebetween that collectively permit passage of liquid and gas therethrough. The permeable packing 114 may also or instead be or comprise metal or non-metal foams having gaps, openings, or other spaces of predetermined size that collectively permit passage of liquid and gas therethrough. The permeable packing 114 may also or instead be or comprise metal or non-metal knitted or woven wire meshes, expanded mesh packings, or other members having openings of predetermined size that collectively permit passage of liquid and gas therethrough. The permeable packing 114 may also or instead be or comprise overlapping or alternating rings, blades, baffles, or other members defining channels, gaps, or other spaces that alternate (or zigzag) in opposing directions and collectively permit the passage of liquid and gas therethrough. The permeable packing 114 may also or instead be or comprise a plurality of discs or other members disposed in a concentric and parallel manner, and spaced apart by predetermined distances, thereby defining channels, gaps, or other spaces that collectively permit the passage of liquid and gas therethrough. The various particles and members of the permeable packing 114 may comprise surface areas along which the liquid and gas can flow and contact each other and, thus, facilitate mass transfer between the liquid and gas.

The RPB reactor 100 may further comprise a liquid inlet 118 extending into the housing 110 and a liquid outlet 128 extending out of the housing 110. The liquid inlet 118 may be located on an upper side of the housing 110 above the rotor 112 and the liquid outlet 128 may be located on a lower side of the housing 110 below the rotor 112. The liquid inlet 118 may be fluidly connected with a liquid distributor 120 disposed within the axial space 116, thereby facilitating transfer of a liquid from the liquid inlet 118 to the axial space 116. The RPB reactor 100 may further comprise a gas inlet 126 extending into the housing 110 and a gas outlet 130 extending out of the housing 110. The gas inlet 126 may be located on a lateral side of the housing 110, extending through the inner circumferential surface 109 of the housing 110 to fluidly connect a gas source with the annular space 117. The gas inlet 126 may be located along (or adjacent) the outer circumferential surface 115 of the rotor 112 or otherwise fluidly connected with the annular space 117. The gas outlet 130 may be located on an upper side of the housing 110 above the rotor 112. The gas outlet 130 may be fluidly connected with the axial space 116, thereby facilitating the transfer of the gas from the axial space 116 to the gas outlet 130 and out of the RPB reactor 100.

The gas inlet 126 may be configured to direct the gas injected into the housing 110 of the RPB reactor 100 tangentially with respect to the outer circumferential surface 115 of the rotor 112, as indicated by arrows 136, to thereby cause the rotor 112 to rotate within and with respect to the housing 110. In other words, the gas inlet 126 may be configured to direct the gas into the annular space 117 and flow tangentially against (or along) the outer circumferential surface 115 of the rotor 112 through the annular space 117, as indicated by the arrows 136, while at the same time flowing in the radially inward direction through the permeable packing 114 of the rotor 112, as indicated by the arrows 134. While the gas flows around and through the rotor 112, angular momentum is gradually transferred from the gas to the rotor 112, generating a tangential force (or torque) against the rotor 112 to thereby cause the rotor 112 to rotate within and with respect to the housing 110.

During operations of the RPB reactor 100, while the rotor 112 (and the permeable packing 114) is being rotated about the axis 111 by the gas that is being injected (e.g., pumped) into the annular space 117 via the gas inlet 126, a liquid may be transferred (e.g., pumped) into the housing 110 via the liquid inlet 118 and injected into the axial space 116 (also known as the flooding area) via the liquid distributor 120. A centrifugal force (or gravity) field generated by the rotation of the rotor 112 may cause the liquid to flow in a radially outward direction with respect to the central axis 111 through the permeable packing 114, as indicated by arrows 132. Furthermore, the centrifugal force from the rotor 112 on the liquid may thin the liquid, thereby increasing the flow of the liquid radially outward as shown by arrows 132. At the same time, a pressure differential may cause the gas flowing through the annular space 117 tangentially with respect to the outer circumferential surface 115, as indicated by the arrows 136, to flow in a radially inward direction with respect to the central axis 111 through the permeable packing 114, as indicated by arrows 134. While the liquid and gas flow in opposing directions through the permeable packing 114, the liquid and gas contact each other along the surfaces of the various particles and/or members forming the permeable packing 114. As the liquid and gas contact each outer, gas components (e.g., carbon dioxide, pollutants) are transferred from the gas to the liquid. After the gas reaches the axial space 116, the gas may be transferred out of the housing 110 via the gas outlet 130, and after the liquid reaches the annular space 117, the liquid may be transferred out of the housing 110 via the liquid outlet 128. In some embodiments, the liquid absorbs carbon dioxide via chemical absorption from the gas, such that the gas exiting through the gas outlet 130 has a lower concentration of carbon dioxide than the gas entering the gas inlet 126.

In some embodiments, the liquid includes a solvent that is partially miscible with water or immiscible with water. The liquid may include a nitrogenous base, such as an organic amine, a non-organic amine, and one or more of a diluent and water. The nitrogenous base of the NAS may include an amine (e.g., a primary amine, a secondary amine), an amidine, a guanidine (e.g., 1,1,3,3-tetramethylguanidine (“TMG”)), a triazole (e.g., 1,2,3-triazole, 1,2,4-triazole), or combinations thereof. In some embodiments, the nitrogenous base includes a hydrophobic amine. The amine may include one or more of N-methylbenzylamine (NMBA), 2-fluoro-N-methylbenzylamine, 3-fluoro-N-methylbenzylamine, 4-fluoro-N-methylbenzylamine, 3,5-difluorobenzylamine, 1,4-diazabicyclo-undec-7-ene (“DBU”), 1,4-diazabicyclo-2,2,2-octane, piperazine (“PZ”), triethylamine (“TEA”), 1,8-diazabicycloundec-7-ene, monoethanolamine (“MBA”), diethyl amine (“DEA”), ethylenediamine (“EDA”), methyldiethanolamine (MDEA), 2-amino 1-propanol (AMP), 1,3-diamino propane, 1,4-diaminobutane, hexamethylenediamine, 1,7-diaminoheptane, diethanolamine, diisopropylamine (“DIPA”), 4-aminopyridine, pentylamine, hexylamine, heptylamine, octylamine, nonyl amine, decylamine, tert-octylamine, dioctylamine, dihexylamine, 2-ethyl-1-hexylamine, 2-fluorophenethylamine, 3-fluorophenethylamine, 4-fluorophenethylamine, D-4-fluoro-alpha-methylbenzylamine, L-4-fluoro-alpha-methylbenzylamine, imidazole, benzimidazole, N-methyl imidazole, 1-trifluoroacetylimidazole, or combinations thereof. In some embodiments, the hydrophobic amine includes N-methylbenzylamine.

Thus, during operations of the RPB reactor 100, the energy of the entering stream of gas may be used to rotate the rotor 112. The gas entering the annular space 117 has a tangential velocity component at the outer circumferential surface 115 of the rotor 112, which converts the angular momentum of the entered gas into rotational energy. This approach facilitates self-adjustment of rotational speed as the gas flow rate changes during operations. The gas-energy-driven rotation of the rotor 112 propels the liquid flow radially outward by the centrifugal acceleration, as indicated by the arrows 132, thereby creating crossflow mixing to enhance mass transfer between the liquid and gas. The gas migration in the radially inward direction, as indicated by the arrows 134, generates a gradual angular momentum transfer from the gas stream to the rotor 112, thereby facilitating a uniform slip of the gas relative to the permeable packing 114. This results in a uniform mixing of the gas with the liquid, which flows radially outward and slips in the circumferential direction, as indicated by the arrows 136, due to Coriolis forces. Using the angular momentum of the gas stream to rotate the rotor 112 may eliminate the use of a motor, a motor shaft connecting the motor to the rotor 112, and a fluid seal between the motor shaft and the housing 110, thereby reducing the size and weight, and simplifying the design of the RPB reactor 100.

In some embodiments, the RPB reactor 100 may be configured to rotate the rotor 112 without a motor connected to the rotor 112. In some embodiments, the RPB reactor 100 may be configured to primarily (e.g., more than 50, 75, or 90% of the torque) rotate the rotor 112 with the angular momentum of the gas stream, while a motor connected to the rotor 112 supplements torque or assists startup of the rotor 112. Accordingly, the motor may be eliminated entirely or reduced in size through utilization of the angular momentum of the gas stream to rotate the rotor 112.

The angular momentum generated by the gas stream at the gas inlet 126 is also absorbed by the outflowing liquid based on an angular momentum conservation equation (i.e., Euler's equation for turbomachinery) as set forth below in Equation (1).

$${\dot{m}}_{g} ( {c}_{2 u , g} {r}_{2} - {c}_{1 u} {r}_{1} ) = {\dot{m}}_{l} {ω}_{RPB} {r}_{2}^{2} \qquad ( 1 )$$

wherein r₁ is the radial distance between the central axis 111 and the inner circumferential surface 113 and r₂ is the radial distance between the central axis 111 and the outer circumferential surface 115. Hence, while approximating that r₁<<r₂, the angular speed of the rotor 112 can be computed based on Equation (2) as set forth below.

$${ω}_{RPB} = \frac{{\dot{m}}_{g}}{{\dot{m}}_{l}} ( \frac{{c}_{2 u , g}}{{r}_{2}} - \frac{{c}_{1 u} {r}_{1}}{{r}_{2}^{2}} ) ∼ \frac{{\dot{m}}_{g}}{\dot{{m}_{l}}} \frac{{c}_{2 u , g}}{{r}_{2}} = \frac{{\dot{m}}_{g}}{\dot{{m}_{l}}} {ω}_{g 2} \qquad ( 2 )$$

Accordingly, the rotational speed of the rotor 112 is proportional to the gas liquid mass ratio times the angular velocity of the gas entering the RPB reactor 100. The rotational speed of the rotor 112 may be controlled through control of the gas entering the RPB reactor 100, control of the liquid injected into the axial space 116, or any combination thereof.

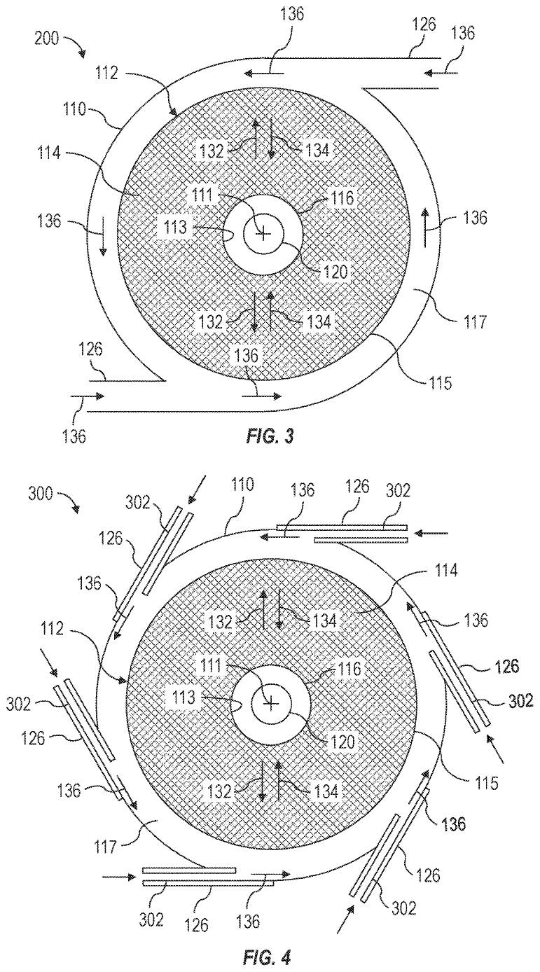

FIG. 3 is a schematic sectional axial view of an example implementation of an RPB reactor 200 according to one or more aspects of the present disclosure. The RPB reactor 200 may be an example implementation of the RPB reactor 100 shown in FIGS. 1 and 2, and may comprise one or more features and/or modes of operation of the RPB reactor 100, including where indicated by the same reference numerals. Accordingly, the following description refers to FIGS. 1-3, collectively.

The RPB reactor 200 may comprise a plurality of gas inlets 126 each extending into the housing 110. The gas inlets 126 may each be located on the lateral side of the housing 110, extending through the inner circumferential surface 109 of the housing 110 to fluidly connect the gas source with the annular space 117. The gas inlets 126 may be located along (or adjacent) the outer circumferential surface 115 of the rotor 112 and distributed around the rotor 112. Each gas inlet 126 may be configured to direct the gas tangentially with respect to the outer circumferential surface 115 of the rotor 112, as indicated by the arrows 136, to thereby cause the rotor 112 to rotate within and with respect to the housing 110. In other words, the gas inlets 126 may be configured to direct the gas into the annular space 117 and flow tangentially against (or along) the outer circumferential surface 115 of the rotor 112 through the annular space 117, as indicated by the arrows 136, while at the same time flowing in the radially inward direction through the permeable packing 114 of the rotor 112, as indicated by the arrows 134. While the gas flows around and through the rotor 112, angular momentum is gradually transferred from the gas to the rotor 112, generating a tangential force (or torque) against the rotor 112 to thereby cause the rotor 112 to rotate within and with respect to the housing 110.

Although the RPB reactor 200 is shown comprising two gas inlets 126, it is to be understood that the RPB reactor 200 according to one or more aspects of the present disclosure may comprise three, four, five, six, or more gas inlets 126 each extending into the annular space 117 of the housing and distributed around the outer circumferential surface 115 of the rotor 112. When two or more gas inlets 126 are implemented, the gas inlets 126 may be distributed symmetrically around the rotor 117 to therefore equalize and cancel out radial forces imparted to the rotor 112 by the gas being injected into the annular space 117 of the housing 110.

FIG. 4 is a schematic sectional axial view of an example implementation of an RPB reactor 300 according to one or more aspects of the present disclosure. The RPB reactor 300 may be an example implementation of the RPB reactors 100, 200 shown in FIGS. 1-3, and may comprise one or more features and/or modes of operation of the RPB reactors 100, 200, including where indicated by the same reference numerals. Accordingly, the following description refers to FIGS. 1-4, collectively.

The RPB reactor 300 may comprise a gas nozzle 302 within or at each of the gas inlets 126 extending into the housing 110. Each nozzle 302 may be located on the lateral side of the housing 110, extending through the inner circumferential surface 109 of the housing 110 to fluidly connect the source of the gas with the annular space 117. The gas nozzles 302 may be located along (or adjacent) the outer circumferential surface 115 of the rotor 112 and distributed around the rotor 112. Each gas nozzle 302 may be configured to direct the gas tangentially with respect to the outer circumferential surface 115 of the rotor 112, as indicated by the arrows 136, to thereby cause the rotor 112 to rotate within the housing 110. Although the RPB reactor 300 is shown comprising six gas nozzles 302, it is to be understood that the RPB reactor 300 according to one or more aspects of the present disclosure may comprise one, two, three, four, five, or more gas nozzles extending into the annular space 117 of the housing 110 and distributed around the outer circumferential surface 115 of the rotor 112.

Each gas nozzle 302 may be configured to adjust (i.e., change or control) a flow rate of the gas flowing therethrough and, thus, flow rate of the gas being injected into the annular space 117. For example, each gas nozzle 302 may comprise a gas passage having a cross-sectional area that can be adjusted to therefore adjust the flow rate of the gas being injected into the annular space 117. Each gas nozzle 302 may be or comprise, for example, a needle valve or other flow rate control valve. Each gas nozzle 302 may be configured to shut off (or close) the flow of the gas into the annular space 117, such as to control rotational speed of the rotor 112.

FIG. 5 is a schematic sectional axial view of an example implementation of an RPB reactor 400 according to one or more aspects of the present disclosure. The RPB reactor 400 may be an example implementation of the RPB reactors 100, 200, 300 shown in FIGS. 1-4, and may comprise one or more features and/or modes of operation of the RPB reactors 100, 200, 300, including where indicated by the same reference numerals. Accordingly, the following description refers to FIGS. 1-5, collectively.

The RPB reactor 400 may comprise a volute (or scroll) 402 having a cross-sectional area that progressively decreases with or along a circumferential position around the rotor 112 as the gas flows tangentially around the rotor 112 through the annular space 117, as indicated by the arrows 136, starting from the gas inlet 126 and terminating at a volute tongue 404. The volute 402 may be defined between or otherwise by the outer circumferential surface 115 of the rotor 112 and the inner circumferential surface 109 of the housing 110 that progressively nears the outer circumferential surface 115 of the rotor 112, starting from the gas inlet 126 and terminating at the volute tongue 404 (i.e., portion of the inner circumferential surface 109 of the housing 110 adjacent the gas inlet 126 and in close proximity to the outer circumferential surface 115 of the rotor 112). Thus, the volute 402 may be or comprise at least a portion of the annular space 117 having a cross-sectional area that progressively decreases with or along the circumferential position around the rotor 112. The volute 402 may thus force the gas in the radially inward direction into and through the permeable packing 114, as indicated by the arrows 134, as the gas flows tangentially through the volute 402 around the rotor 112, as indicated by the arrows 136.

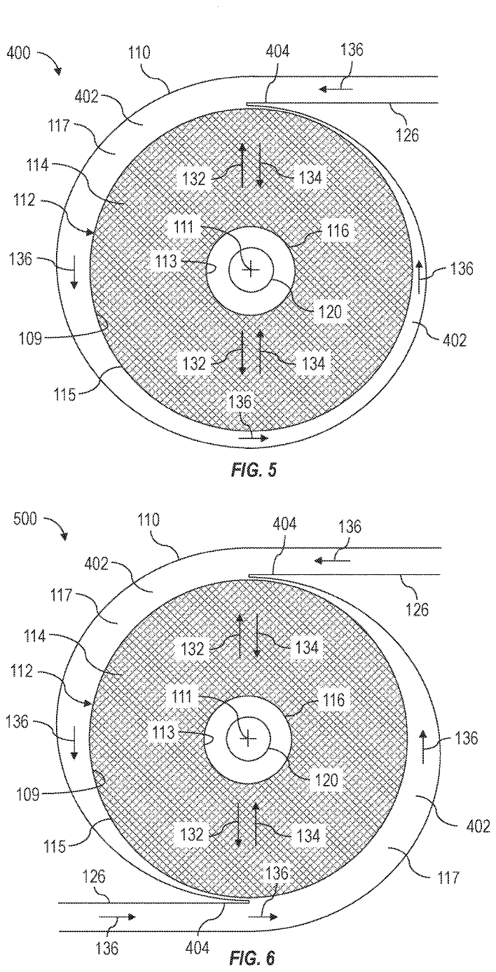

FIG. 6 is a schematic sectional axial view of an example implementation of an RPB reactor 500 according to one or more aspects of the present disclosure. The RPB reactor 500 may be an example implementation of the RPB reactors 100, 200, 300, 400 shown in FIGS. 1-5, and may comprise one or more features and/or modes of operation of the RPB reactors 100, 200, 300, 400 including where indicated by the same reference numerals. Accordingly, the following description refers to FIGS. 1-6, collectively.

The RPB reactor 500 may comprise a plurality of volutes 402, each having a cross-sectional area that progressively decreases with or along the circumferential position around the rotor 112 as the gas flows tangentially through the annular space 117 around the rotor 112, as indicated by the arrows 136, starting from a corresponding gas inlet 126 and terminating at a corresponding volute tongue 404. Each volute 402 may be defined between or otherwise by the outer circumferential surface 115 of the rotor 112 and the inner circumferential surface 109 of the housing 110 that progressively nears the outer circumferential surface 115 of the rotor 112, starting from at a corresponding gas inlet 126 and terminating at a corresponding volute tongue 404. Thus, each volute 402 may be or comprise at least a portion of the annular space 117 having a cross-sectional area that progressively decreases with or along the circumferential position around the rotor 112. Each volute 402 may thus force the gas in a radially inward direction into and through the permeable packing 114, as indicated by the arrows 134, as the gas flows tangentially through the volute 402 around the rotor 112, as indicated by the arrows 136. Although the RPB reactor 500 is shown comprising two volutes 402, it is to be understood that the RPB reactor 500 according to one or more aspects of the present disclosure may comprise three, four, or more volutes each extending partially around the outer circumferential surface 115 of the rotor 112.

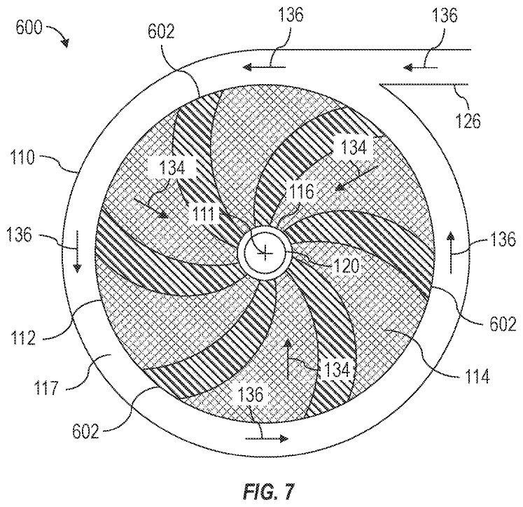

FIG. 7 is a schematic sectional axial view of an example implementation of an RPB reactor 600 according to one or more aspects of the present disclosure. The RPB reactor 600 may be an example implementation of the RPB reactors 100, 200, 300, 400, 500 shown in FIGS. 1-6, and may comprise one or more features and/or modes of operation of the RPB reactors 100, 200, 300, 400, 500, including where indicated by the same reference numerals. Accordingly, the following description refers to FIGS. 1-7, collectively.

The RPB reactor 600 may comprise a plurality of impeller blades 602 within or otherwise as part of the rotor 112. Each impeller blade 602 may be configured to direct the gas flowing tangentially with respect to the outer circumferential surface 115 of the rotor 112 through the annular space 117, as indicated by the arrows 136, in a radially inward direction through the permeable packing 114, as indicated by the arrows 134, to thereby cause the rotor 112 to rotate within and with respect to the housing 110. In other words, each impeller blade 602 may change the direction of (i.e., redirect) the gas injected into the annular space 117 via the inlet 126 from flowing in the tangential direction, as indicated by the arrows 136, to flow in the radially inward direction, as indicated by the arrows 134, to absorb angular momentum from the gas and generate a tangential force (or torque) against the impeller blade 602 and thereby cause the rotor 112 to rotate within the housing 110. Each impeller blade 602 may extend radially through or along the permeable packing 114 to thereby force or redirect the gas flowing tangentially with respect to the outer circumferential surface 115 of the rotor 112 through the annular space 117, as indicated by the arrows 136, to flow in in the radially inward direction through the permeable packing 114, as indicated by the arrows 134. In some embodiments, each impeller blade 602 extends across the rotor 112 from the annular space 117 towards the axial space 116. In some embodiments, one or more impeller blades 602 extends partially from the annular space 117 towards the axial space 116. That is, one or more impeller blades 602 may extend from the annular space 117 approximately 10, 25, 50, or 75% of the radius of the rotor 112 towards the axial space 116.

In view of the entirety of the present disclosure, a person having ordinary skill in the art will readily recognize that the present disclosure introduces an apparatus comprising a rotating packed bed reactor comprising: a housing comprising a gas inlet, a liquid inlet, a gas outlet, and a liquid outlet; and a rotor disposed within the housing. The rotor is rotatable with respect to the housing and comprises an outer circumferential surface. The rotor comprises a permeable packing configured to facilitate contact between a liquid and a gas passing through the permeable packing while the rotor rotates with respect to the housing. The gas inlet is configured to direct the gas tangentially with respect to the outer circumferential surface of the rotor to thereby cause the rotor to rotate with respect to the housing.

The gas inlet may be configured to direct the gas tangentially against the outer circumferential surface of the rotor to generate a tangential force against the rotor and thereby cause the rotor to rotate with respect to the housing.

The housing may comprise an inner circumferential surface that progressively nears the outer circumferential surface of the rotor from the gas inlet along a circumferential position around the rotor.

The housing and rotor may collectively define a volute having a progressively decreasing cross-sectional area from the gas inlet along a circumferential position around the rotor. The gas inlet may be a first gas inlet, the volute may be a first volute, the housing may comprise a second gas inlet, and the housing and rotor may also collectively define a second volute having a progressively decreasing cross-sectional area from the gas inlet along the circumferential position around the rotor.

The gas inlet may be a first gas inlet, the housing may comprise a second gas inlet on an opposite side of the housing from the first gas inlet, and the second gas inlet may be configured to direct the gas tangentially with respect to the outer circumferential surface of the rotor to thereby cause the rotor to rotate with respect to the housing.

The gas inlet may be one of a plurality of gas inlets of the housing, the gas inlets may be distributed around the rotor, and each gas inlet may be configured to direct the gas tangentially with respect to the outer circumferential surface of the rotor to thereby cause the rotor to rotate with respect to the housing.

The gas inlet may be or comprise a gas nozzle configured to adjust a flow rate of the gas flowing therethrough.

The rotor may comprise a plurality of impeller blades. The impeller blades may extend radially through or along the permeable packing.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the scope of the present disclosure.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. An apparatus comprising:
a rotating packed bed reactor comprising:
a housing comprising a gas inlet, a liquid inlet, a gas outlet, and a liquid outlet; and
a rotor disposed within the housing, wherein:
the rotor is rotatable with respect to the housing;
the rotor comprises an outer circumferential surface;
the rotor comprises a permeable packing configured to facilitate contact between a liquid and a gas passing through the permeable packing while the rotor rotates with respect to the housing; and
the gas inlet is configured to direct the gas tangentially with respect to the outer circumferential surface of the rotor to thereby cause the rotor to rotate with respect to the housing.

2. The apparatus of claim 1 wherein the gas inlet is configured to direct the gas tangentially against the outer circumferential surface of the rotor to generate a tangential force against the rotor and thereby cause the rotor to rotate with respect to the housing.

3. The apparatus of claim 1 wherein the housing comprises an inner circumferential surface that progressively nears the outer circumferential surface of the rotor from the gas inlet along a circumferential position around the rotor.

4. The apparatus of claim 1 wherein the housing and rotor collectively define a volute having a progressively decreasing cross-sectional area from the gas inlet along a circumferential position around the rotor.

5. The apparatus of claim 1 wherein:
the gas inlet is a first gas inlet;
the housing comprises a second gas inlet on an opposite side of the housing from the first gas inlet; and
the second gas inlet is configured to direct the gas tangentially with respect to the outer circumferential surface of the rotor to thereby cause the rotor to rotate with respect to the housing.

6. The apparatus of claim 1 wherein:
the gas inlet is one of a plurality of gas inlets of the housing;
the gas inlets are distributed around the rotor; and
each gas inlet is configured to direct the gas tangentially with respect to the outer circumferential surface of the rotor to thereby cause the rotor to rotate with respect to the housing.

7. The apparatus of claim 1 wherein the gas inlet is or comprises a gas nozzle configured to adjust a flow rate of the gas flowing therethrough.

8. The apparatus of claim 1 wherein the rotor further comprises a plurality of impeller blades.

9. The apparatus of claim 8 wherein the impeller blades extend radially through or along the permeable packing.

10. The apparatus of claim 8, wherein the impeller blades extend from the outer circumferential surface partially toward an axial surface proximate the gas outlet.

11. The apparatus of claim 1, wherein the permeable packing comprises a mesh material.

12. The apparatus of claim 1, wherein the liquid comprises an amine and the gas comprises carbon dioxide, wherein the liquid is configured to absorb carbon dioxide from the gas.

12. A method of operating a rotating packed bed reactor, comprising:
injecting a liquid into an axial space of a rotor, wherein the rotor comprises a central axis within the axial space;
driving the rotor about the central axis via directing a gas through a first gas inlet of a housing of the rotating packed bed reactor in a tangential direction, wherein the rotor is disposed within the housing, the rotor is rotatable with respect to the housing, and the rotor comprises a permeable packing;
flowing the liquid radially from the axial space to an outer circumferential surface of the rotor based at least in part by a centrifugal force of the rotor on the liquid;
directing the liquid through a liquid outlet of the housing; and
directing the gas radially through the outer circumferential surface to a gas outlet of the housing.

13. The method of claim 12, comprising driving the rotor about the central axis without a motor.

14. The method of claim 12, wherein the housing and the rotor collectively define a volute having a progressively decreasing cross-sectional area from the first gas inlet along a circumferential position around the rotor.

15. The method of claim 12, comprising driving the rotor about the central axis via directing the gas through the first gas inlet of the housing and directing the gas through a second gas inlet of the housing on an opposite side of the housing from the first gas inlet, wherein the gas through the first gas inlet and the second gas inlet is in a tangential direction with respect to the outer circumferential surface of the rotor.

16. The method of claim 12, comprising controlling a rotational speed of the rotor by controlling a flow of the gas through the first gas inlet.

17. The method of claim 13, comprising controlling a rotational speed of the rotor by controlling injecting the liquid into the axial space of the rotor.

18. The method of claim 12, wherein the rotor comprises a plurality of impeller blades.

19. The method of claim 12, wherein the permeable packing is configured to facilitate contact between the liquid and the gas by crossflow mixing within the rotor, and a first carbon dioxide concentration of the gas at the first gas inlet is greater than a second carbon dioxide concentration of the gas at the gas outlet.

20. The method of claim 19, wherein the liquid comprises an amine, and the liquid is configured to absorb carbon dioxide from the gas.
